(19) United States
(12) Patent Application Publication
(10) Pub. No.: US 2008/0245940 A1
(43) Pub. Date: Oct. 9, 2008

(54) MOUNTING SYSTEM FOR WINDOW TREATMENT

(76) Inventor: Garrick Brown, Mansfield, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 12/059,748

(22) Filed: Mar. 31, 2008

Related U.S. Application Data
(63) Continuation-in-part of application No. 11/784,042, filed on Apr. 5, 2007.

(51) Int. Cl. A47H 1/14; A47G 5/02; E06B 9/26

(52) U.S. Cl. 248/251; 160/166.1; 160/238; 160/330

(57) ABSTRACT

An adjustable mounting system for use with a variety of window treatments comprises a head rail, an adjustable support rod, and one or more clips for coupling the support rod to the head rail. The mounting system is preferably non-invasive and does not damage window casings. The mounting system may be installed very quickly and easily, without the need for any tools. The head rail is adapted for use with a wide variety of window treatment assemblies.

This is a continuation-in-part application of application Ser. No. 11/784,042, filed 5 Apr. 2007, the entire contents of which are hereby incorporated by reference.

### BACKGROUND

1. Field of the Invention

The present invention relates to mounting systems for window treatments.

2. Description of Related Art

Most systems for mounting window treatments include at least two brackets that are configured to receive a head rail of a window treatment. The brackets are fastened to the window casing or the wall in front of the window casing with screws, bolts, or nails, so that the brackets can support the head rail of the window treatment. This leaves holes and damage in the window casing or wall that must be repaired if the window treatment is replaced. On small window casings, such as those having a width of about four feet or less, only two brackets, one mounted adjacent each side of the window casing, are used. This often results in the middle portion of the head rail sagging over time. On larger windows, center brackets must be used to support the load of the head rail and window treatment.

Another disadvantage of these conventional mounting systems is that they can be very difficult and time consuming for an average consumer to install. For installations in which the brackets are screwed to the wall in front of the window frame, the widths of the brackets have to be measured, the brackets must be properly leveled, and pilot holes must be made, before the brackets can be mounted. This requires that the installer have certain tools and skills. Further, the installation of the brackets can cause permanent damage to the window casing or the wall to which they are mounted.

Some mounting systems do not require screw-mounted brackets. These non-intrusive mounting systems often use a supplemental cap or mounting bracket for one or both ends of the head rail. These independently functioning brackets are commonly spring-loaded or use a lever and cam system to generate compression. However, these supplemental caps have several disadvantages, as well. In particular, the compression that is achieved is often only great enough to support shear-type drapes and very light-weight curtains. Such brackets do not generate enough strength to support heavy rolling shades, mini-blinds, or drapes. In particular, after the window treatment has been opened and closed repeatedly, these types of brackets, much like conventional screw-in brackets, often must rely upon the strength and integrity of the head rail itself to support the window treatment. This often results in the middle portion of the head rail sagging over time.

Although great strides have been made in the area of mounting systems for window treatments, many shortcomings remain.

### BRIEF DESCRIPTION OF THE DRAWINGS

FIG. 1 is a rear view of a mounting system for a window treatment, according to an exemplary embodiment of the present application;

FIGS. 2A-2C are partial front views of the adjustable support rod of the mounting system of FIG. 1 shown in different stages of the installation process;

FIG. 3 is an oblique view of the clip of the mounting system of FIG. 1 the according to an exemplary embodiment;

FIG. 4 is a cross-sectional view of the mounting system of FIG. 1 taken at IV-IV;

FIGS. 5A-5E are oblique views of exemplary embodiments of the end cap of the adjustable support rod of FIGS. 2A-2C;

FIGS. 6A-6E are cross-sectional views of exemplary embodiments of window treatments utilizing the mounting system of FIG. 1;

FIG. 7 is a rear perspective view of an alternative embodiment of a mounting system;

FIG. 8A is a partially broken-away perspective view of an adjustable end of the mounting system of FIG. 7;

FIG. 8B is an exploded view of the adjustable end shown in FIG. 8A;

FIG. 9 is an exploded view of a non-adjustable end of the mounting system of FIG. 7;

FIG. 10 is a cross-sectional view of an adjustment collar taken along section line X-X shown in FIG. 8B;

FIG. 11 is a perspective view of a clip member of the mounting system of FIG. 7;

FIG. 12 is a cross-sectional view of the mounting system of FIG. 1 taken along section line XII-XII shown in FIG. 1; and

FIG. 13 is an exploded perspective view of an end cap of the mounting system of FIG. 7.

### DETAILED DESCRIPTION

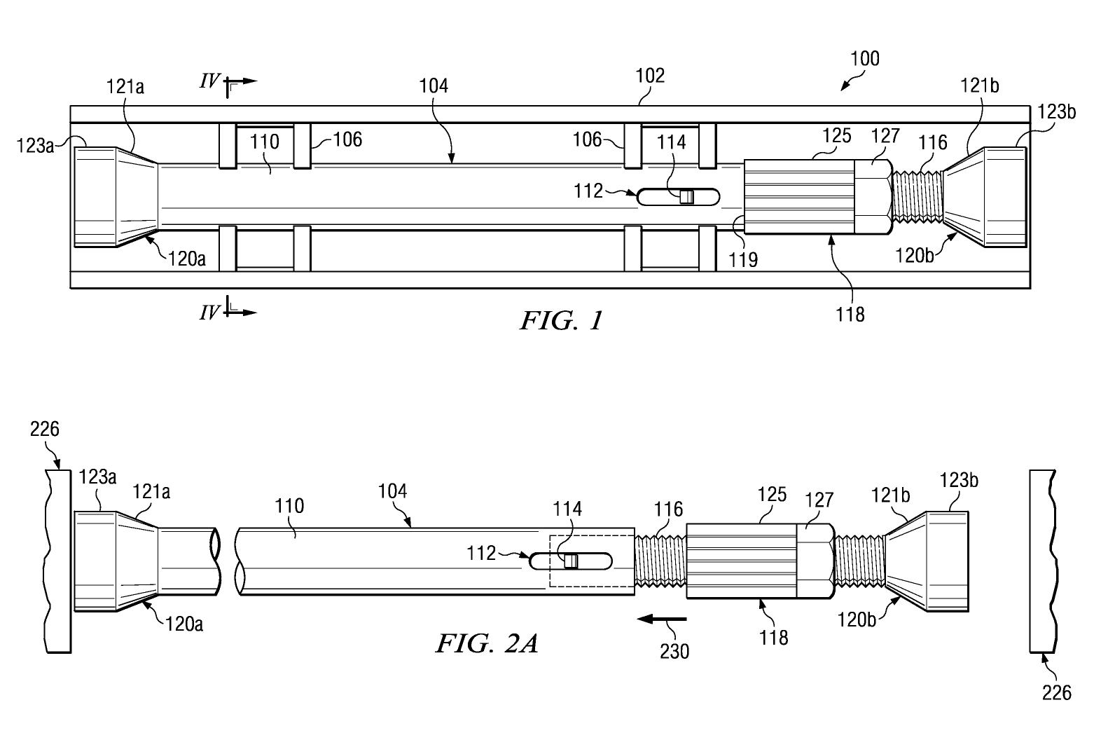

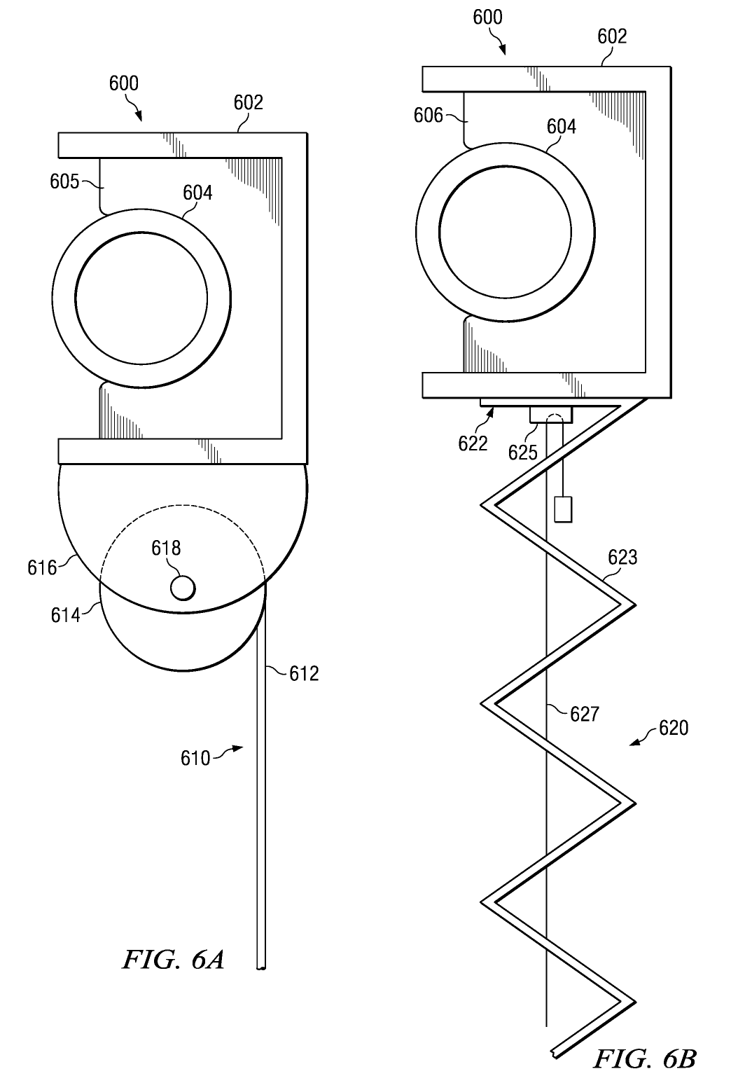

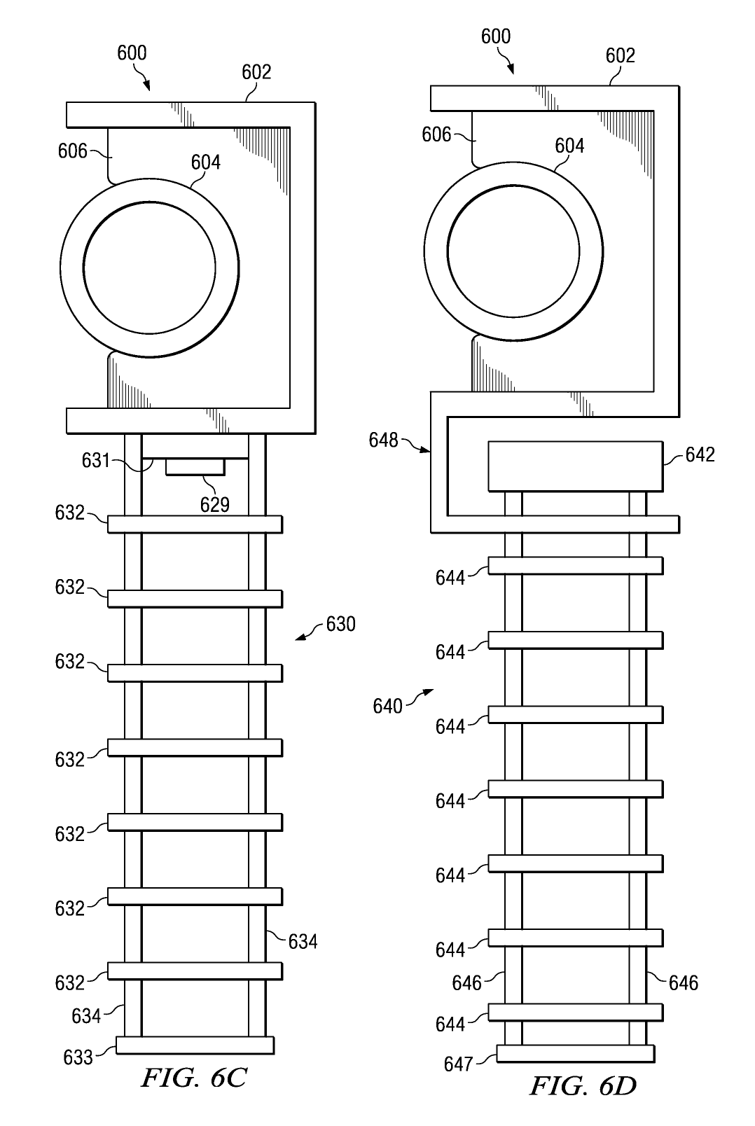

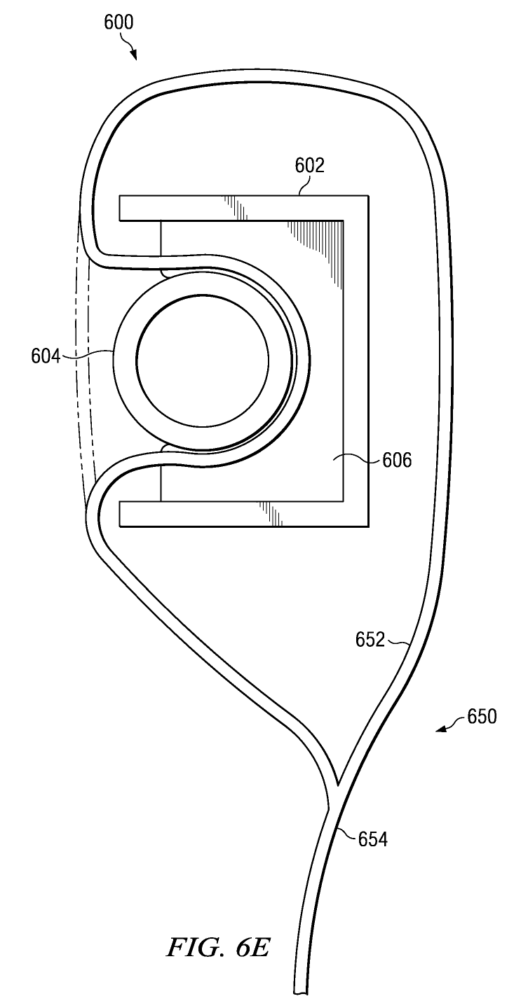

Referring to FIG. 1 in the drawings, a rear view of the preferred embodiment of a mounting system 100 for a window treatment is illustrated. Mounting system 100 comprises a head rail 102, an adjustable support rod 104, and at least one clip member 106. In the preferred embodiment, clip members 106 releasably grip support rod 104, so as to couple head rail 102 to support rod 104. Mounting system 100 is configured and adapted to support a wide variety of window treatments, such as window treatments 610, 620, 630, 640, and 650 depicted in FIGS. 6A-6E. As explained more fully herein, window treatments 610, 620, 630, 640, and 650 may be integral with head rail 102, or may be coupled to or carried by head rail 102 according to a wide variety of means.

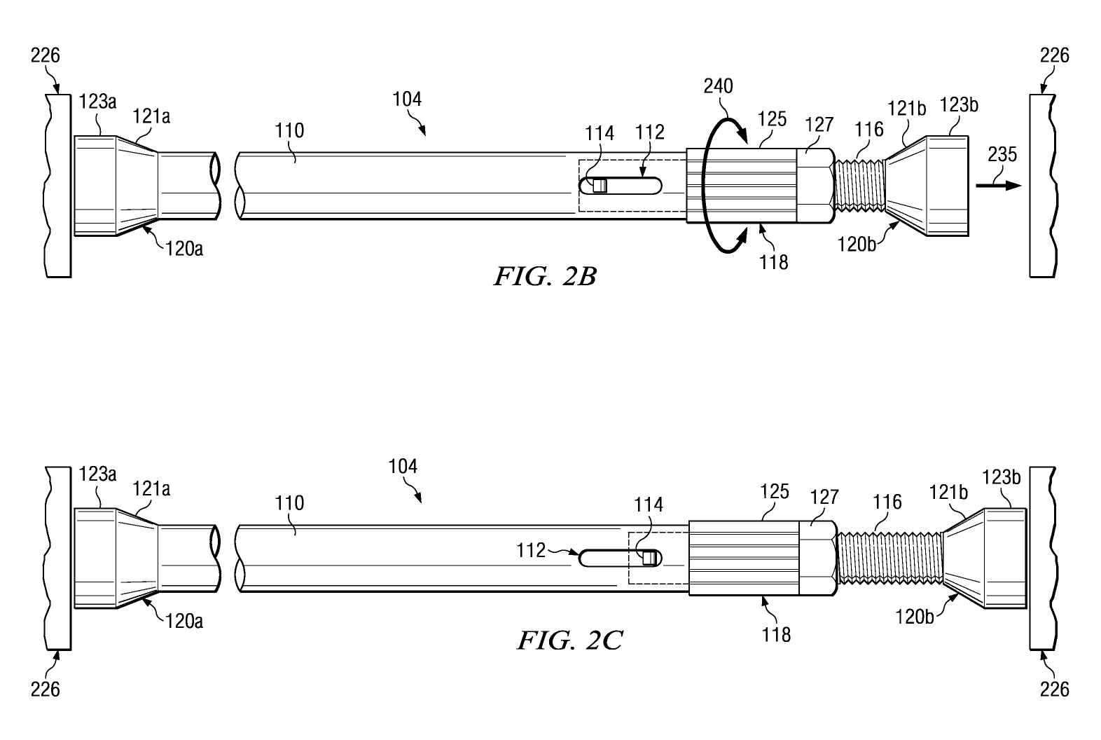

Support rod 104 comprises a tubular rod portion 110, a guide cutout 112, a sliding guide 114 that protrudes into guide cutout 112, an adjustment shaft 116, an adjustment collar 118, and end caps 120a and 120b. End caps 120a and 120b comprise coupling portions 121a and 121b and pad portions 123a and 123b, respectively. Support rod 104 has an adjustable length and is configured to be installed into a window casing 226 (see FIGS. 2A-2C) by a press-fit attachment. Although support rod 104 is depicted as having a round cross-sectional shape, in alternate embodiments, support rod 104 may be comprised of a variety of shapes, including, but not limited to, oval, elliptical, square, rectangular, triangular, hexagonal, and so forth. In addition, although support rod 104 is depicted as a rigid rod, it will be appreciated that in another embodiment, support rod 104 comprises a multi-piece, telescoping, spring-loaded compression rod. Sliding guide 114 is coupled to adjustment shaft 116 and slidingly fits within guide cutout 112. In this manner, the length of guide cutout 112 determines the overall adjustment length of mounting system 100. Because sliding guide 114 protrudes into guide cutout 112, adjustment shaft 116 is prevented from rotating relative to support rod 104.

Adjustment collar 118 preferably comprises a finger tightening portion 125 and an integral wrench tightening portion 127. Finger tightening portion 125 preferably includes gripping means that allow a user to get a firm hand or finger grip on adjustment collar 118. For example, in FIG. 1, finger tightening portion 125 comprises upraised ridges. It will be appreciated that other gripping means may be utilized with finger tightening portion 125, such as upraised ridges, knurls, slots, and notches, and that the gripping means may be either integral with finger tightening portion 125 or may be a separate component, such as a non-slip film or grip tape. Wrench tightening portion 127 preferably has a hexagonal cross-sectional shape, so that a conventional hexagonal wrench may be used to tighten, loosen, and otherwise adjust adjustment collar 118. Although support rod 104 is configured such that sufficient torque may be imparted to adjustment collar 118 by simple hand tightening, wrench tightening portion 127 provides a means for users who may not be able to generate sufficient hand strength, such as elderly users or users with disabilities, to adjust adjustment collar 118.

Adjustment collar 118 is operably coupled to adjustment shaft 116. Although adjustment shaft 116 is free to translate axially according to the length of guide cutout 112, adjustment collar 118 restricts the movement of adjustment shaft 116 relative to support rod 104 by butting up against an end 119 of support rod 104. In this manner, rotation of adjustment collar 118 in the appropriate direction relative to adjustment shaft 116, causes adjustment shaft 118 and end cap 120b to translate outward away from support rod 104 and into contact with window casing 226, thereby forming a press-fit of mounting system 100 into window casing 226. Although mounting system 100 has been shown with a threaded coupling as a means for adjustment, it should be understood that other means for adjustment, such as ratchet systems and clamping systems may be utilized.

In the preferred embodiment, the length of head rail 102 matches the distance between the walls of window casing 226. This allows head rail 102 to conceal end caps 120a and 120b after installation. It should be understood that in some applications it may be necessary or desirable to trim head rail 102 to fit appropriately within window casing 226. The length of support rod 104 may also be trimmed, particularly from the end adjacent end cap 120a, to fit window casing 226.

It is preferred that the interior cross-sectional shape of head rail 102 and the exterior cross-sectional shape of at least one portion of end caps 120a and 120b be similar. This ensures that head rail 102 will conceal end caps 120a and 120b and not rotate relative to support rod 104 after installation. In the example of FIG. 1, head rail 102 has a generally square interior cross-sectional shape and pad portions 123a and 123b of end caps 120a and 120b, respectively, have square exterior cross-sectional shapes. It will be appreciated that other shapes, sizes, and configurations of head rail 102, end cap 120a, and/or end cap 120b may be utilized to conceal ends caps 120a and 120b and prevent movement of head rail 102 relative to support rod 104.

Mounting system 100 may be installed very quickly and easily, without the need for any tools. First, support rod 104 is press fit into window casing 226, a process more fully described in FIGS. 2A through 2C. Mounting system 100 is easily leveled during installation. Because support rod 104 is merely press-fit into window casing 226, mounting system 100 is non-invasive and does not damage window casing 226. Once support rod 104 is secured within window casing 226, head rail 102 is simply snapped onto support rod 104 via clip members 106. This allows head rail 102 to be quickly and easily removed from support rod 104, while allowing support rod 104 to remain in place in window casing 226. It will be appreciated that support rod 104 may also be quickly and easily removed and reinstalled without damaging window casing 226.

Another advantage of mounting system 100 is that the weight of head rail 102 and any associated window treatment can be more evenly distributed along support rod 104, thus preventing sagging. Clip members 106 serve to transfer and distribute loads from head rail 102, and any window treatment associated with head rail 102, through support rod 104 to window casing 226. Although only two clip members 106 are shown in FIG. 1, it will be appreciated that any number of clip members 106 may be utilized, depending upon the load to be distributed.

Referring now to FIGS. 2A-2C in the drawings, the process of installing mounting system 100 in window casing 226 is illustrated. First, adjustment collar 118 is loosened, i.e., rotated in one of the directions indicated by arrow 240, to allow adjustment shaft 116 to advance into the interior portion of tubular rod portion 110. This provides clearance for support rod 104 to be inserted between the sides of window casing 226. The distance that adjustment shaft 116 may be recessed into or extended out from tubular rod portion 110 is limited by the length of guide cutout 112. Once the length of support rod 104 has been adjusted to allow adequate clearance between window casings 226, adjustment collar 118 is seated against end 119 of tubular rod portion 110. Then, end cap 120a is placed into contact with one side of window casing 226. These steps are shown in FIG. 2B.

Next, adjustment collar 118 is tightened, i.e., rotated in one of the directions indicated by arrow 240, to force adjustment shaft 116 in the direction of arrow 235. This causes end cap 120b to be advanced toward window casing 226. End cap 120b is advanced in this manner until end cap 120a makes contact with window casing 226. As explained in more detail herein, end caps 120a and 120b may comprise compliant material or other means for positively engaging window casing 226. Thus, additional torque may be imparted upon adjustment collar 118 after the initial contact between end cap 120a and window casing 226. This increases the amount of friction between the end caps 120a, 120b and the window casing 226, thereby ensuring a firm press fit between support rod 104 and window casing 226. Support rod 104 may include means for preventing adjustment collar from loosening once tightened to the desired position. For example, a tension nut or retaining clip may be added to ensure that adjustment collar does not inadvertently loosen once tightened.

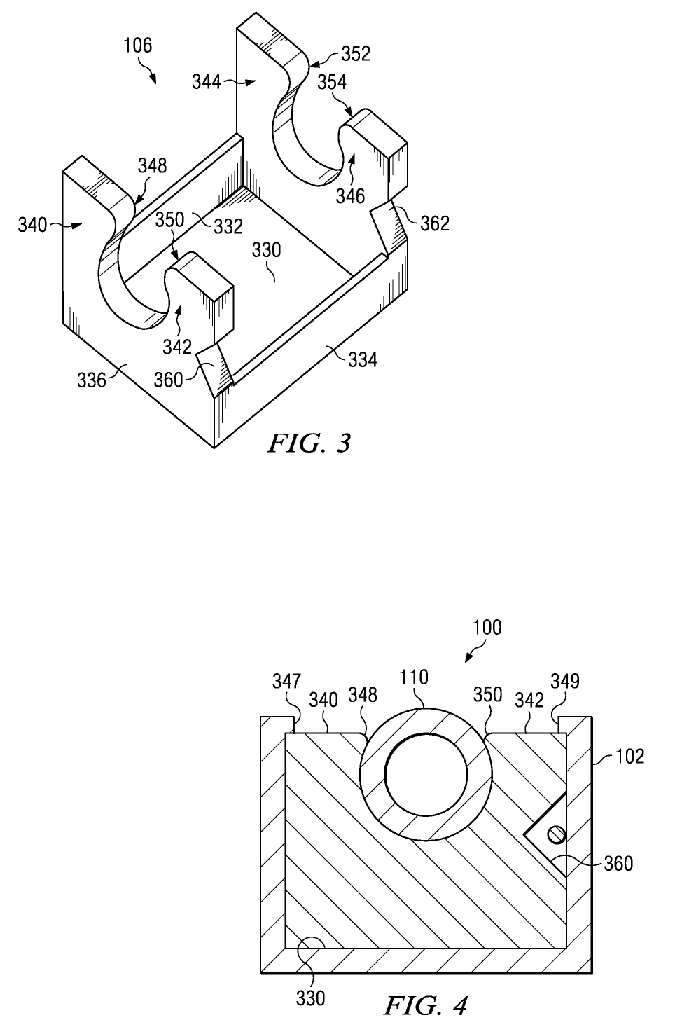

Referring now to FIG. 3 in the drawings, the preferred embodiment of clip member 106 is illustrated. Clip member 106 comprises a back portion 330, a top portion 332, a bottom portion 334, a left side portion 336, and a right side portion 338. Top and bottom portions 332 and 334 extend forward from back portion 330, and connect left and right side portions 336 and 338. Left side portion 336 comprises left top wing portion 340 and left bottom wing portion 342. Likewise, right side portion 338 comprises a right top wing portion 344 and a right bottom wing portion 346. Left top wing portion 340 and left bottom wing portion 342 each comprise a gripping portion 348 and 350, respectively. In a similar fashion, right top wing potion 344 and right bottom wing portion 346 each comprise a gripping portion 352 and 354, respectively. Gripping portions 348, 350, 352, and 354 are shaped, formed, and configured to releasably grip and retain support rod 104. In the preferred embodiment, gripping portions 348, 350, 352, and 354 are smooth curves that are separated by a distance that is shorter than the diameter of support rod 104. This allows support rod 104 to be snapped into place in the void spaces formed by left and right side portions 336 and 338 and by gripping portions 348, 350, 352, and 354. Although right and left side portions 336 and 338 have been depicted in the exemplary embodiment as being shaped to generally grasp and retain a round shaped rod, in other alternative embodiments, right and left side portions 336 and 338 may be adapted to grip and retain rods of other shapes, including but not limited to, oval, elliptical, square, rectangular, triangular, hexagonal, and so forth. However, it should be understood that gripping portions 348, 350, 352, and 354 may have other shapes, sizes and dimensions, and may comprise other means for releasably retaining support rod 104.

Clip member 106 is preferably made of any appropriate material, including but not limited to, plastic, metal, rubber, nylon, and others. However, clip member 106 may be varied in many ways, including size and shape, depending upon the particular implementation desired. In some alternative embodiments back portion 330 may not be present. In other alternative embodiments, top and/or bottom portions 332 and 334 may be missing or may extend to a greater or lesser extent from a back portion 330.

It is preferred that clip member 106 be securely fastened to head rail 102 at selected locations. This can be achieved by snapping clip member 106 into the interior portion of head rail 102, by press-fitting clip member 106 into the interior portion of head rail 102, by sliding clip member 106 into the interior portion of head rail 102, or other suitable means. In an alternative embodiment, clip member 106 is integrally formed with head rail 102. In another alternative embodiment, clip member 106 may be adjustably relocated along the length of head rail 102 by sliding clip member 106 within the channel formed by head rail 102.

It will be appreciated that clip member 106 may perform other functions in addition to releasably retaining head rail 102 to support rod 104. For example, clip member 106 may contain one or more string guides, apertures, notches, or slots, such as notches 360 and 362, to accommodate strings, cables, and other operating controls used to operate various window treatments associated with head rail 102.

Referring now to FIG. 4 in the drawings, a cross-sectional view of mounting bracket 100 taken at IV-IV of FIG. 1 is illustrated. Notch 360 allows a string 450 of a widow treatment to pass through clip member 106. Notch 360 is optional and may not be needed depending on the particular implementation being contemplated and the particular window treatment being used. As is shown, head rail 102 may include tabs 347 and 349 that allow head rail 102 to snap onto and grip clip members 106 and end caps 120a and 120b. Tabs 347 and 349 further prevent head rail 102 from moving relative to support rod 104 and window casing 226.

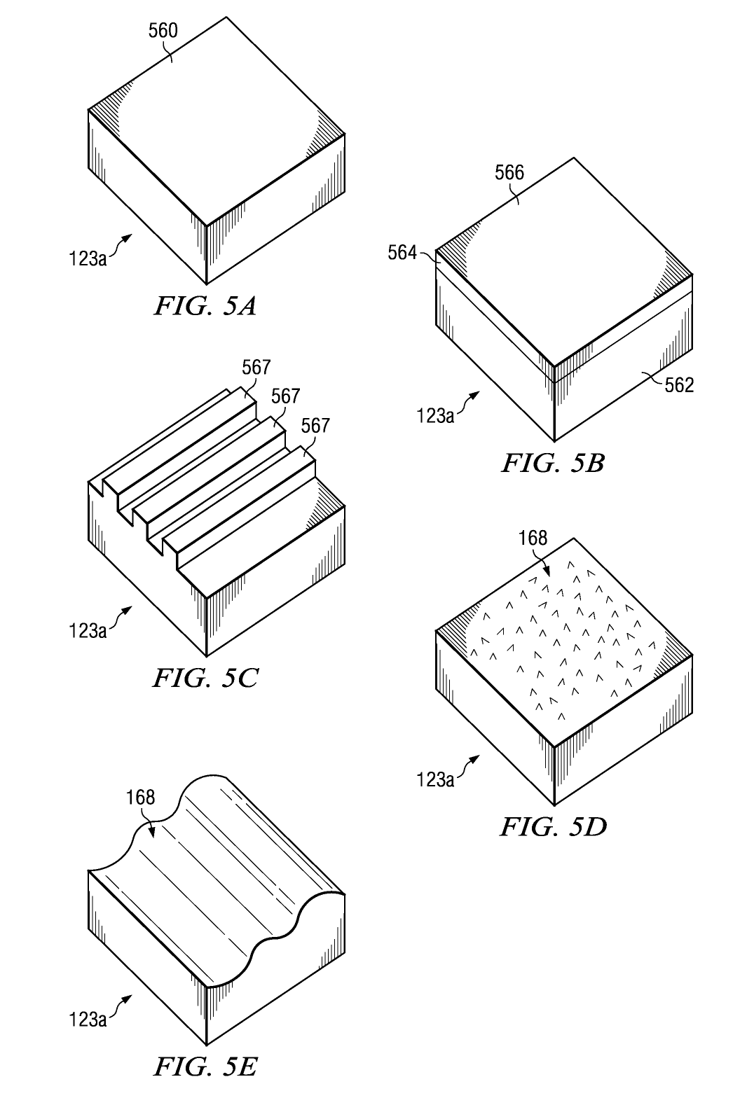

Referring now to FIGS. 5A-5E in the drawings, the preferred embodiment and various alternative embodiments for pad portions 123a and 123b are illustrated. In the preferred embodiment, pad portions 123a and 123b are made of the same material and have the same size and shape; however, it will be appreciated that pad portions 123a and 123b may be made of different materials and/or have different sizes and shapes. For simplicity, only pad portion 123a will be shown and described in FIGS. 5A-5E. In the preferred embodiment, which is depicted in FIG. 1 and FIG. 5A, pad portion 123a comprises a square shape, which prevents rotation of head rail 102 relative to support rod 104, and which, when abutted against the upper sides of the window casing 226, helps to prevent support rod 104 from rotating relative to window casing 226. As shown in FIG. 5A, pad portion 123a has a flat, smooth surface 160.

In FIG. 5B, pad portion 123a is a multi-layer pad having a first layer 562 and at least one other layer, such as a top layer 564. Top layer 564 is shown having a flat, smooth surface 566. Layers 562 and 564 may be of the same material or may be of differing materials. For example, top layer 566 may form an adhesive-type surface. For those embodiments in which top layer 564 is an adhesive layer, a release liner (not shown) may also be used to protect the adhesive until installation. In FIG. 5C, pad portion 123a comprises raised grooves 567. It will be appreciated that raised grooves 567 may be arranged in a wide variety of patterns and shapes, including multi-directional patterns, overlapping patterns, and checkerboard patterns. In FIG. 5D, pad portion 123a comprises a knurled surface 168. The sizes of the individual knurls may vary depending upon whether it is desired that the knurls pierce the surface of window casing 226. In FIG. 5E, pad portion 123a comprises a wavy surface 168. Although a generally square shape has been utilized in FIGS. 5A-5E, it will be appreciated that other geometric shapes, including but not limited to, oval, elliptical, circular, rectangular, triangular, hexagonal, and so forth, may be used instead or in combination. In addition, in an alternative embodiment, end caps 120a and 120b may be configured to allow for the use of nails, screws, clamps, or other suitable fasteners, to aid in securing end caps 120a and 120b to window casing 226.

Mounting system 100 is capable of use with a wide variety of different types of window treatments, including but not limited to, Venetian blinds, rolling shades, vertical blinds, mini-blinds, curtains, drapes, and so forth. In addition, mounting system 100 allows these different types of window treatments to be quickly and easily interchanged among each other. Further, an optional valence (not shown) may be coupled to head rail 102. Utilization of an appropriately shaped, sized, and trimmed valence also allows potential gaps between head rail 102 and window casing 226 to be concealed.

Referring now to FIGS. 6A-6E in the drawings, mounting system 100 is illustrated with some exemplary types of window treatments. The window treatments in FIGS. 6A-6E, as well as other types of window treatments, may be coupled to head rail 102 as separate components, or may be integral with head rail 102.

In FIG. 6A, a mounting system 600 comprises a head rail 602, a support rod 604, and a clip member 605, and a rolling blind 610 as a window treatment. Rolling blind 610 comprises a blind member 612, roller assembly 614, and a mounting bracket 616 for mounting rolling blind 610 to header rail 602. Roller assembly 614 is attached to mounting bracket 616 by pin 618. Pin 618 may be any type of appropriate device, including but not limited to axles, tabs, bolts, screws, rods, and so forth.

In the embodiment of FIG. 6B, rolling blind 610 has been replaced by a pleated shade assembly 620. Pleated shade assembly 620 comprises a top portion 622, a pleated shade portion 623, an optional control system 625, and an optional control string 627. Control system 625 and control string 627 allow pleated shade portion 623 to be easily raised an lowered. Top portion 622 is adapted for connection to head rail 602, preferably by the inclusion of a layer of adhesive between head rail 602 and top portion 622. However, top portion 622 may be connected to head rail 602 by other means, such as snaps, clamps, guide rails and other means. It should be appreciated that control system 625 and parts of control string 627 may be carried by, concealed by, or integrated with head rail 602.

In the embodiment of FIG. 6C, rolling blind 610 has been replaced by a mini-blind assembly 630. Mini-blind assembly 630 comprises a plurality of individual slats 632, one or more guide strings 634, a header 631, a bottom plate 633, and a control system 629. Control system 629, guide strings 634, and bottom plate 631 allow slats 632 to be easily raised, lowered, opened, and closed. Header 631 is adapted for connection to head rail 602, preferably by the inclusion of a layer of adhesive between head rail 602 and header 631. However, header 631 may be connected to head rail 602 by other means, such as screws, snaps, clamps, guide rails, and other means. It should be appreciated that control system 629 and parts of guide strings 627 may be carried by, concealed by, or integrated with head rail 602.

In the embodiment of FIG. 6D, rolling blind 610 has been replaced by an alternative mini-blind assembly 640. Mini-blind assembly 640 comprises a header 642, an adapted 648, a plurality of slats 644, guide strings 646, a bottom plate 647, and a control system disposed within header 642. The control system, guide strings 646, and bottom plate 647 allow slats 644 to be easily raised, lowered, opened, and closed. Header 642 is coupled to head rail 602 via adapter 648. However, header 642 may be connected to head rail 602 by other means, such as screws, snaps, clamps, guide rails, and other means. It should be appreciated that parts of guide strings 646 may be carried by, concealed by, or integrated with head rail 602 and/or adapter 648.

In the embodiment of FIG. 6E, rolling blind 610 has been replaced by a curtain assembly 650. Curtain assembly 650 comprises a plurality of loops 652 and a drape portion 654. In the depicted exemplary embodiment, curtain 650 is connected to head rail 602 via loop 652. In one embodiment, loop 652 goes around support rod 604, between support rod 604 and the interior of head rail 602. In an alternative embodiment, loop 652 completely encloses mounting bracket 600, as indicated by the dotted lines.

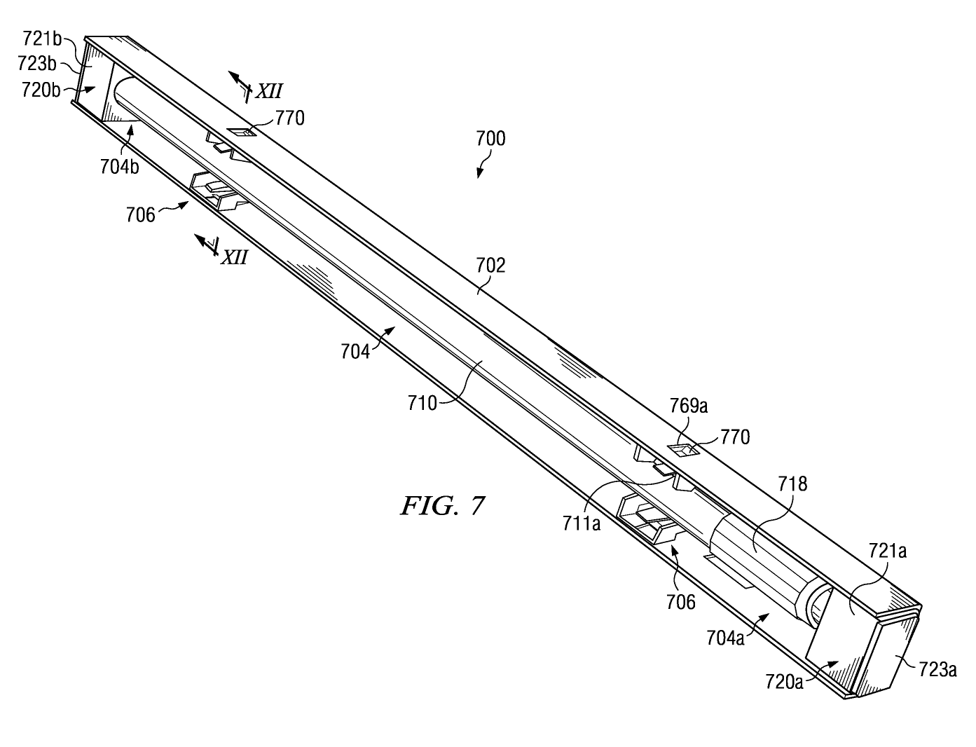

Referring now to FIG. 7 in the drawings, a rear perspective view of an alternative embodiment of a mounting system 700 for a window treatment is illustrated. Mounting system 700 comprises a head rail 702, an adjustable support rod 704, and at least one clip member 706. The illustrated embodiment of the adjustable support rod 704 includes an adjustable end 704a and a non-adjustable end 704b. Alternative embodiments can include a second adjustable end 704a in place of the non-adjustable end 704b. Clip members 706 releasably grip support rod 704, so as to couple head rail 702 to support rod 704. Mounting system 700 is configured and adapted to support a wide variety of window treatments, such as window treatments 610, 620, 630, 640, and 650 depicted in FIGS. 6A-6E and described above. As explained more fully above, window treatments 610, 620, 630, 640, and 650 may be integral with head rail 702, or may be coupled to or carried by head rail 702 according to a wide variety of means.

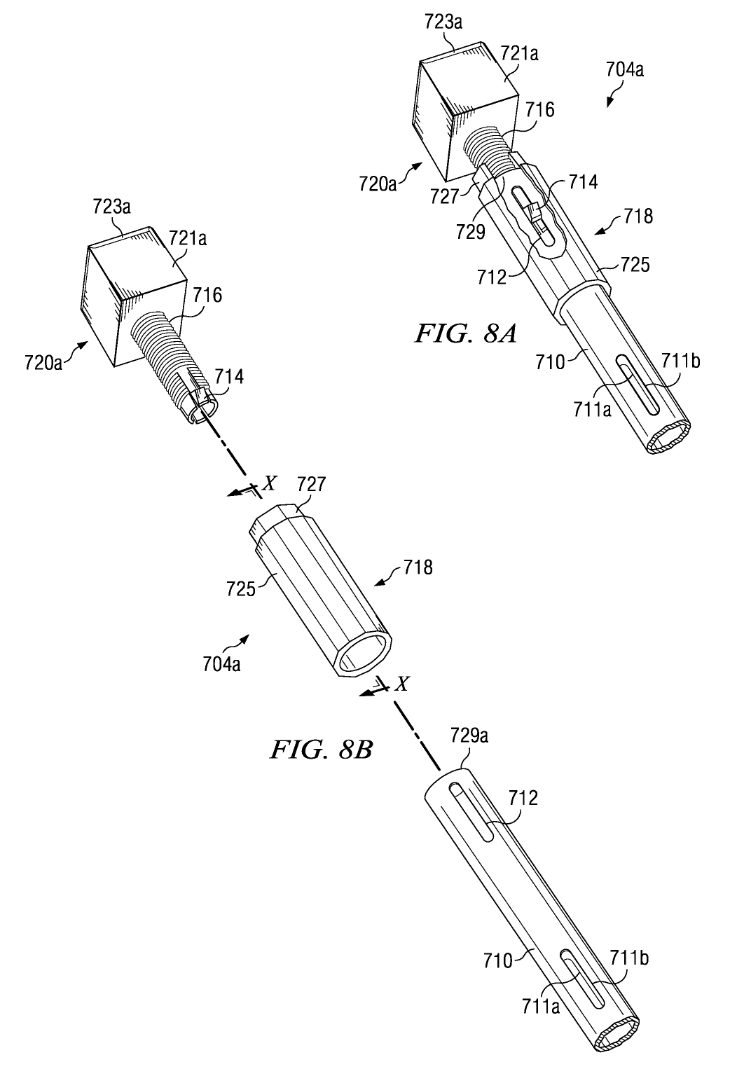

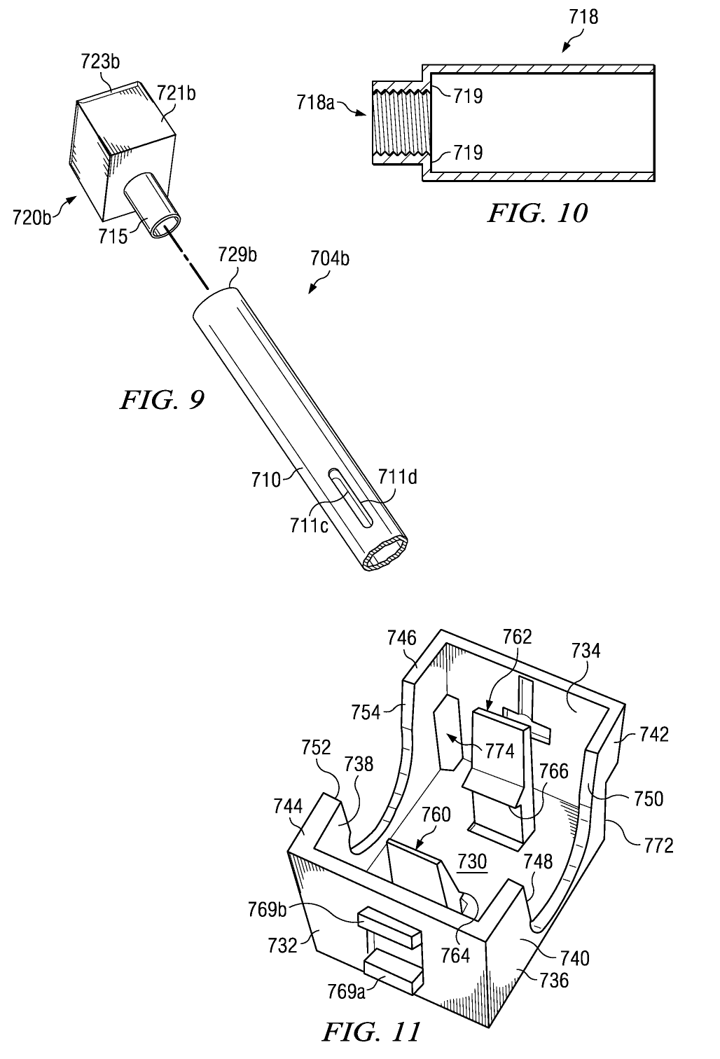

Reference is next made also to FIGS. 8A, 8B, and 9. FIG. 8A shows a partially broken-away perspective view of the adjustable end 704a of the support rod 704. FIG. 8B shows an exploded view of the adjustable end 704a of the support rod 704. FIG. 9 shows an exploded view of the non-adjustable end 704b of the support rod 704. The support rod 704 comprises a tubular rod portion 710 and a guide cutout 712. End cap 721a comprises an adjustment shaft 716 and a sliding guide 714 that protrudes into guide cutout 712. The sliding guide 714 can be pressed down into the support rod to allow the end cap 721a to be removed from the support rod 704. An adjustment collar 718 connects the end cap 721a to the support rod 704. End caps 720a and 720b comprise coupling portions 721a and 721b and pad portions 723a and 723b, respectively. Support rod 704 has an adjustable length and is configured to be installed into a window casing 226 (see FIGS. 2A-2C) by a press-fit attachment. Although tubular rod portion 710 is depicted as having a round cross-sectional shape, in alternate embodiments, tubular rod portion 710 may be comprised of a variety of shapes, including, but not limited to, oval, elliptical, square, rectangular, triangular, hexagonal, and so forth. In addition, although tubular rod portion 710 is depicted as a rigid rod, it will be appreciated that in alternative embodiments, tubular rod portion 710 can comprise a multi-piece, telescoping, spring-loaded compression rod. Sliding guide 714 is integrally coupled to adjustment shaft 716 and slidingly fits within guide cutout 712. In this manner, the length of guide cutout 712 determines the overall adjustment length of mounting system 700. Because sliding guide 714 protrudes into guide cutout 712, adjustment shaft 716 is prevented from rotating relative to support rod 704.

Adjustment collar 718 preferably comprises a finger tightening portion 725 and an integral wrench tightening portion 727. Finger tightening portion 725 preferably includes gripping means that allow a user to get a firm hand or finger grip on adjustment collar 718. For example, in FIGS. 7, 8A, and 8B, finger tightening portion 725 comprises multiple facets and upraised ridges. It will be appreciated that other gripping means may be utilized with finger tightening portion 725, such as upraised ridges, knurls, slots, and notches, and that the gripping means may be either integral with finger tightening portion 725 or may be a separate component, such as a non-slip film or grip tape. Wrench tightening portion 727 preferably has a hexagonal cross-sectional shape, so that a conventional hexagonal wrench may be used to tighten, loosen, and otherwise adjust adjustment collar 718. Although support rod 704 is configured such that sufficient torque may be imparted to adjustment collar 718 by simple hand tightening, wrench tightening portion 727 provides a means by which users that may not be able to generate sufficient hand strength, such as elderly users or users with disabilities, can adjust adjustment collar 718.

As shown in FIG. 9, the coupling portion 721b comprises a post 715. In the illustrated embodiment, the post 715 is generally cylindrical in shape and has an external diameter that is substantially the same as the internal diameter of the support rod 704 such that the post 715 can be slid into an end 729b of the support rod 704 and preferably fit at least somewhat snugly therein, meaning that there is at least enough friction between the post 715 and the support rod 704 that the coupling portion 721b cannot freely rotate or move relative to the support rod 704 without some external force other than that of gravity being applied thereto. This arrangement allows the coupling portion 721b to be repeatedly removed from and reinstalled onto the support rod 704. It may be desirable to remove the coupling portion 721b during installation so that some length of the support rod 704 can be cut away from the end 729b in order to provide for a better fit into a window casing 226. In alternative embodiments, the post can have any shape necessary to conform to the inside of the support rod 704. In still further embodiments, the coupling portion 721b can be attached to the support rod 704 using any known attachment method, including removable, non-removable, and integral attachment methods.

As is best seen in FIGS. 8B and 9, the support rod 704 includes slots 711a, 711b, 711c, and 711d. Slots 711a and 711b are opposite each other near the end 729a of the support rod 704 (see FIG. 8B), and slots 711c and 711d are opposite each other near the end 729b of the support rod 704 (see FIG. 9). The slots 711a-d are provided for securing the support rod 704 in the clip members 706 as described below.

Referring is next made to FIG. 10, which shows a cross-sectional view of the adjustment collar 718 taken along section line X-X shown in FIG. 8B. Adjustment collar 718 is operably coupled to adjustment shaft 716. Specifically, adjustment collar 718 includes a tapped end 718a that is configured for coupling with a correspondingly threaded adjustment shaft 716. Although adjustment shaft 716 is free to translate axially according to the length of guide cutout 712, adjustment collar 718 has an internal shoulder 719 that restricts the movement of adjustment shaft 716 relative to support rod 704 by butting up against an end 729a of support rod 704. In this manner, rotation of adjustment collar 718 in the appropriate direction relative to adjustment shaft 716 causes adjustment shaft 718 and end cap 720a to translate outwardly away from support rod 704 and into contact with window casing 226 (see FIG. 2A), thereby forming a press-fit of mounting system 700 into a window casing 226. Although mounting system 700 has been shown with a threaded coupling as a means for adjustment, it should be understood that other means for adjustment, such as ratchet systems and clamping systems, may be utilized.

In the preferred embodiment, the length of head rail 702 matches the distance between the walls of window casing 226. This allows head rail 702 to conceal end caps 720a and 720b after installation. It should be understood that in some applications it may be necessary or desirable to trim head rail 702 to fit appropriately within window casing 226. The length of support rod 704 may also be trimmed, particularly from the end adjacent end cap 720b, to fit window casing 226.

It is preferred that the interior cross-sectional shape of head rail 702 and the exterior cross-sectional shape of at least one portion of end caps 720a and 720b be similar. This ensures that head rail 702 will conceal end caps 720a and 720b and not rotate relative to support rod 704 after installation. In the example of FIG. 7, head rail 702 has a generally square interior cross-sectional shape and pad portions 723a and 723b of end caps 720a and 720b, respectively, have square exterior cross-sectional shapes. It will be appreciated that other shapes, sizes, and configurations of head rail 702, end cap 720a, and/or end cap 720b may be utilized to conceal ends caps 720a and 720b and prevent movement of head rail 702 relative to support rod 704.

Mounting system 700 may be installed very quickly and easily, without the need for any tools, in substantially the same manner described above in connection with FIGS. 2A through 2C. Mounting system 700 is easily leveled during installation. Because support rod 704 is merely press-fit into window casing 226, mounting system 700 is non-invasive and does not damage window casing 226. Once support rod 704 is secured within window casing 226, head rail 702 is simply snapped onto support rod 704 via clip members 706. This allows head rail 702 to be quickly and easily removed from support rod 704, while allowing support rod 704 to remain in place in window casing 226. It will be appreciated that support rod 704 may also be quickly and easily removed and reinstalled without damaging window casing 226.

Another advantage of mounting system 700 is that the weight of head rail 702 and any associated window treatment can be more evenly distributed along support rod 704, thus preventing sagging. Clip members 706 serve to transfer and distribute loads from head rail 702, and any window treatment associated with head rail 702, through support rod 704 to window casing 226. Although only two clip members 706 are shown in FIG. 7, it will be appreciated that any number of clip members 706 may be utilized, depending upon the load to be distributed.

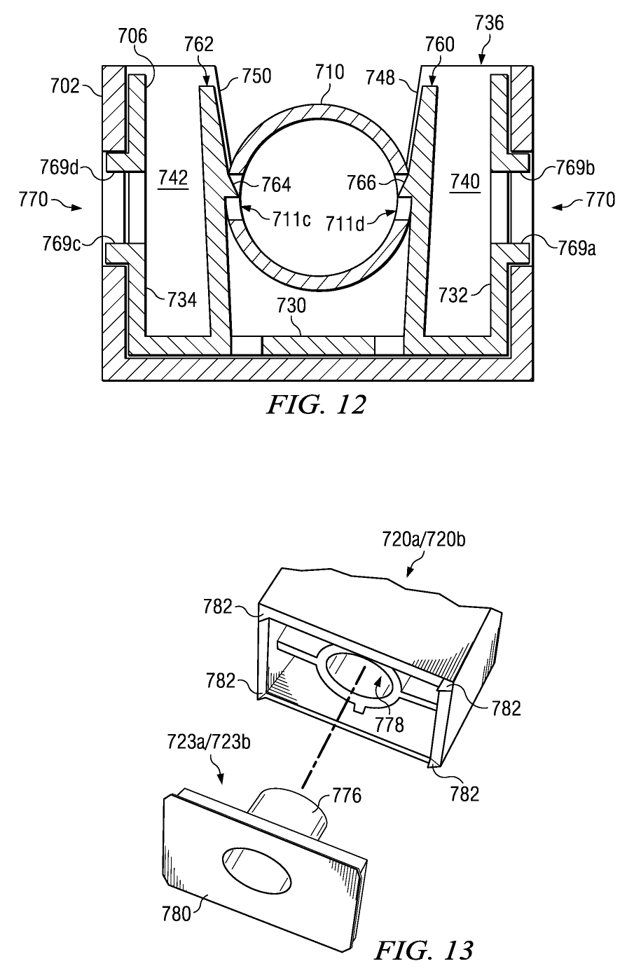

Referring next to FIGS. 11 and 12, an embodiment of clip member 706 is illustrated. FIG. 11 shows a perspective view of the clip member 706, and FIG. 12 shows a cross-sectional view of the mounting system 700 at one of the clip members 706 taken along section lines XII-XII shown in FIG. 7. It should be appreciated that, alternatively, one or more clip members 106 can be used in place of, or in addition to, one or more clip members 706 of the mounting system 700. Also, alternative embodiments of mounting system 100 can include one or more clip members 706 in addition to, or in place of, one or more clip members 106.

Clip member 706 comprises a back portion 730, a top portion 732, a bottom portion 734, a left side portion 736, and a right side portion 738. Top and bottom portions 732 and 734 extend forward from back portion 730, and connect left and right side portions 736 and 738. Left side portion 736 comprises left top wing portion 740 and left bottom wing portion 742. Likewise, right side portion 738 comprises a right top wing portion 744 and a right bottom wing portion 746. Left top wing portion 740 and left bottom wing portion 742 each comprise a guiding portion 748 and 750, respectively. In a similar fashion, right top wing potion 744 and right bottom wing portion 746 each comprise a guiding portion 752 and 754, respectively. Clip member 706 further comprises a top tab 760 and a bottom tab 762. Top tab 760 and bottom tab 762 each comprise a tooth 764 and 766, respectively. The distance between the teeth 764 and 766 is slightly less than the outer diameter of the support rod 704. The teeth 764 and 766 are shaped, formed, and configured to fit within opposing slots 711. Guiding portions 748, 750, 752, and 754 are shaped, formed, and configured to guide the support rod 704 into position between the top and bottom tabs 760 and 762. As the support rod 704 is guided into position between the top and bottom tabs 760 and 762, the tabs 760 and 762 are forced apart and the teeth 764 and 766 snap into the opposing slots 711 in the support rod 704. Once the teeth 764 and 766 snap into the slots 711, a great amount of force would be required to remove the support rod 704 from the clip member 706. However, the tabs 760 and 762 can be pushed apart in order to withdraw the teeth 764 and 766 from the respective slots 711 and remove the support rod 704 from the clip member 706. Thus, this arrangement allows the clip member 706 to releasably grip and retain the support rod 704. Although right and left side portions 736 and 738 have been depicted in the exemplary embodiment as being shaped to generally grasp and retain a round shaped rod, in other alternative embodiments, right and left side portions 736 and 738 may be adapted to grip and retain rods of other shapes, including but not limited to, oval, elliptical, square, rectangular, triangular, hexagonal, and so forth. However, it should be understood that guiding portions 748, 750, 752, and 754 may have other shapes, sizes and dimensions, and may comprise other means for releasably retaining support rod 704.

Clip member 706 is preferably made of any appropriate material, including but not limited to, plastic, metal, rubber, nylon, and others. However, clip member 706 may be varied in many ways, including size and shape, depending upon the particular implementation desired. In some alternative embodiments back portion 730 may not be present. In other alternative embodiments, top and/or bottom portions 732 and 734 may be missing or may extend to a greater or lesser extent from a back portion 730.

It is preferred that clip member 706 be securely fastened to head rail 702 at selected locations. This can be achieved by snapping clip member 706 into the interior portion of head rail 702 such that tabs 769a and 769b snap into a slot 770 in the head rail 702. Alternatively, the clip member 706 can be secured by press-fitting clip member 706 into the interior portion of head rail 702, by sliding clip member 706 into the interior portion of head rail 702, or other suitable means. In alternative embodiments, the clip member 706 can be integrally formed with the head rail 702.

It will be appreciated that clip member 706 may perform other functions in addition to releasably retaining head rail 702 to support rod 704. For example, clip member 706 may contain one or more string guides, apertures, notches, or slots, such as apertures 772 and 774, to accommodate strings, cables, and other operating controls used to operate various window treatments associated with head rail 702.

Referring now to FIG. 13, an exploded perspective view of an end cap 720a/720b is illustrated. In preferred embodiments, the pad portion 723a/723b is removably attached to the end cap 720a/720b. In the illustrated embodiment, the pad portion 723a/723b includes a post 776 that fits snugly into a slot 778 in the end cap 720a/720b. The pad potions 723a/723b include a surface 780, which can be configured according to any of the surfaces described above in connection with FIGS. 5A-5E. The end cap 720a/720b can also optionally include any number of spikes 782 to aid in securing end caps 720a and 720b to window casing 226.

Mounting system 700 is capable of use with a wide variety of different types of window treatments, including but not limited to, Venetian blinds, rolling shades, vertical blinds, mini-blinds, curtains, drapes, and so forth. In addition, mounting system 700 allows these different types of window treatments to be quickly and easily interchanged among each other. Further, an optional valence (not shown) may be coupled to head rail 702. Utilization of an appropriately shaped, sized, and trimmed valence also allows potential gaps between head rail 702 and window casing 226 to be concealed.

The description of the mounting system, support rods, and clips has been presented for purposes of illustration and description, and is not intended to be exhaustive or limited to the form disclosed. Many modifications and variations will be apparent to those of ordinary skill in the art. The embodiments were chosen and described in order to best explain the principles of the mounting system, support rods, and clips, the practical applications thereof, and to enable others of ordinary skill in the art to understand the various embodiments and the various modifications that are suited to particular uses contemplated.

I claim:

1. A mounting system for a window treatment, comprising:
an adjustable support rod adapted to be releasably press fit to a window casing, the adjustable support rod comprising an adjustment collar configured to adjust an amount of pressure applied to the window casing by the adjustable support rod, the adjustable support rod also having at least one pair of opposing slots;
a head rail adapted for releasably connecting to the adjustable support rod and for receiving the window treatment; and
at least one clip member having first and second opposing tabs, each tab having a respective tooth,
wherein the teeth of the opposing tabs releasably connect the adjustable support rod to the head rail.

2. The mounting system of claim 1, wherein the adjustable support rod comprises:
a support rod portion;
a guide cutout disposed in the support rod portion;
an adjustment shaft telescopically coupled to a first end of the support rod portion;
a sliding guide coupled to the adjustment shaft, the sliding guide being operably associated with the guide cutout;
the adjustment collar adjustably carried by the adjustment shaft, the adjustment collar being configured to adjust the position of the adjustment shaft relative to the support rod portion, thereby adjusting the amount of pressure applied to the window casing by the adjustable support rod;
a first end cap disposed on a second end of the support rod; and
a second end cap disposed on an end of the adjustment shaft.

3. The mounting system of claim 2, wherein the first end cap and the second end cap are both square in cross-sectional shape.

4. The mounting system of claim 2, wherein the first end cap and the second end cap have different shapes.

5. The mounting system of claim 2, wherein at least one of the first end cap and the second end cap comprises a gripping surface.

6. The mounting system of claim 5, wherein the gripping surface is a knurled surface.

7. The mounting system of claim 5, wherein the gripping surface is a grooved surface.

8. The mounting system of claim 5, wherein the gripping surface is an adhesive surface.

9. The mounting system of claim 5, wherein the gripping surface is a multi-layered surface.

10. The mounting system of claim 2, wherein the adjustment collar comprises:
a finger tightening portion; and
an integral wrench tightening portion.

11. The mounting system of claim 10, wherein the finger tightening portion comprises:
upraised ridges.

12. The mounting system of claim 1, wherein the support rod is a spring-loaded rod.

13. The mounting system of claim 1, wherein the clip member is integral to the head rail.

14. The mounting system of claim 1, wherein the clip member is moveable within the head rail.

15. The mounting system of claim 1, wherein the clip member snaps into the head rail.

16. The mounting system of claim 2, wherein the head rail comprises:
at least one tab configured to grip at least one of the first end cap or the second end cap.

17. The mounting system of claim 1, further comprising:
a valence coupled to the head rail.

18. A window treatment, comprising:
an adjustable support rod adapted to be frictionally connected to a window casing, wherein the adjustable support rod comprises an adjustment collar configured to adjust the amount of friction between the support rod and the window casing;
a head rail adapted for releasably connecting to the adjustable support rod;
at least one clip member having first and second opposing tabs, each tab having a respective tooth, wherein the teeth of the opposing tabs releasably connect the adjustable support rod to the head rail; and
a window treatment assembly coupled to the head rail.

19. The window treatment of claim 18, wherein the window treatment assembly is releasably coupled to the head rail.

20. The window treatment of claim 18, wherein the window treatment is chosen from the group consisting of:
a Venetian blind;
a mini-blind;
a rolling shade;
a pleated shade;
a curtain; and
a drape.
